(19) United States
(12) Patent Application Publication
(10) Pub. No.: US 2017/0103631 A1
(43) Pub. Date: Apr. 13, 2017

(54) RFID TAG WITH NEUTRALIZING ACTUATORS

(71) Applicant: McIver Technologies, LLC, Honolulu, HI (US)

(72) Inventors: Stephen Buck McIver, Las Vegas, NV (US); Anthony Melvin Makana Paris, Honolulu, HI (US); Kevin Michael White, Honolulu, HI (US)

(21) Appl. No.: 14/809,925

(22) Filed: Oct. 10, 2015

(51) Int. Cl. G08B 13/24

(52) U.S. Cl. CPC G08B 13/2451

(57) ABSTRACT

By modifying a RFID-Tag, with a Hardwired Logic Circuit and by incorporating actuator(s), its efficacy for preventing theft of consumer goods composed of fluids is improved by bypassing efforts made by thieves to deter RFID detection and making the consumer goods they may otherwise take unusable by neutralizing the component fluids.

### CROSS REFERENCE TO PRIOR ART

This application claims the benefit of U.S. Provisional Patent Application No. 62/029,405, filed Jul. 25, 2014.

### TECHNICAL FIELD

The field discussed herein generally relates to anti-theft devices using Radio Frequency Identification (“RFID”).

### BACKGROUND

Retailers suffer substantial losses related to the theft of consumer goods composed of fluids. Currently, most retailers rely on anti-theft devices to secure these goods, most using RFID that employ RFID-Tags that are affixed to the consumer goods. Upon activation the embedded microchip emits and receives radio frequencies, which are transmitted to and from antennae situated at the entrance and exit of a store. If a thief attempts to asport the goods out of the store, the RFID-Tag's embedded microchip determines a differential in the radio frequencies and relays a signal to the antenna sounding an alarm.

However, retailers find the efficacy of RFID limited, as thieves increasingly use booster bags to stifle the technology. When a thief places the consumer goods equipped with an RFID-Tag in a booster bag, the bag's aluminum lining prevents the RFID-Tag's embedded microchip from emitting and receiving radio frequencies and thus sounding the alarm. Given the ease with which thieves can use booster bags to steal these goods, and the ease by which thieves can then resell them as they still are usable, thefts remain rampant.

Instead, retailers have been forced to dilute the retail experience by employing physical barriers, which prevent customers and thieves alike from accessing these goods, like glass cases that are locked. To solve this problem, most innovation in anti-theft technology has focused circumspectly on empowering retailers to detect thieves with booster bags using booster bag detecting scanners stationed adjacent to the antennae at the entrance and exit, rather than deterring thieves from using booster bags in the first place by making the goods they might otherwise be able to steal using the bags unusable when asported.

The foregoing examples of the related art and limitations inherent therein are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

As discussed herein, retailers may benefit from consumer goods composed of fluids with a RFID Tag with Neutralizing Actuator(s) that is discreetly inserted into the product and when armed and signaled, releases a neutralizing agent that renders component fluids unusable.

The RFID Tag with Neutralizing Actuator(s), including advancements disclosed herein, enjoys a discreet design, allowing it to be placed within consumer goods without affecting presentation but that is innovatively equipped to receive a signal that releases a neutralizing agent into the good's component fluid to make it unusable if asported.

Herein is described a RFID Tag with Neutralizing Actuator(s) consisting of a RFID-Tag, Hardwired Logic Circuit with specific logic, a battery, neutralizing agent, actuator(s) and other components.

The embodiment of the RFID Tag with Neutralizing Actuator(s) encompasses a compartment, which may be cylindrical, with a closed vertical space through the center in which the RFID-Tag, Hardwired Logic Circuit, the battery, neutralizing agent, actuator(s) and other components are affixed. Advantageously, this provides a novel way for it to be to discreetly attach it to consumer goods, by placing it in a container with a fluid dispenser that is inserted directly into the fluids

### BRIEF DESCRIPTION OF THE DRAWINGS

FIGS. 1A-C depicts a retail store where consumer goods have been affixed with RFID Tags with Neutralizing Actuator(s), which are armed or disarmed by a hand-held scanner to correspond with antennae at the entrance/exit.

FIG. 2 depicts a consumer good composed of fluid, housed in a bottle with a fluid dispenser, affixed with the RFID Tags with Neutralizing Actuator(s).

FIGS. 3A-B depicts the RFID Tags with Neutralizing Actuator(s), and its components.

FIG. 3C depicts how the RFID-Tag and Hardwired Logic Circuit relates to the actuators and pin switch.

FIG. 4 is a schematic of the Hardwired Logic Circuit logic.

### DETAILED DESCRIPTION

In the following description, details are presented to provide a thorough understanding of the invention. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

“Above” means in a higher place than the compartment, which houses the RFID-Tag.

“Armed” means the state of the RFID-Tag in which the Hardwired Logic Circuit will permit execution of an initiate release signal.

“Adjacent” means contiguous to the antennae located in the store.

“Affix” means to fasten or attach.

“Alarm” means an automated sound that serves to signal the retailer to a theft or call attention to a theft.

“Antennae” mean conductors by which electromagnetic waves or radio frequencies are sent out or received.

“Anti-theft Device” means any contrivance designed to prevent theft.

“Asport” means to take the property of a retailer without permission with the intent to deprive the retailer of dominion.

“Authentication Protocol” means the rules designed to ensure the genuineness of a signal.

“Battery” means a combination of two or more cells electronically connected to work together to produce electrical energy.

“Booster Bag” means a bag used by thieves, with an aluminum lining that prevents consumer goods equipped with a RFID-Tag inside from sending or receiving signals.

“Ceiling” means the overhead interior non-conductive filler surface of the compartment which houses the RFID-Tag.

“Circuitry Lead” means an electrical connection consisting of a length of wire or metal pad used as physical support to transfer power to the RFID-Tag's circuits.

“Circular” means having the form of a circle or round.

“Closed” means having or forming a boundary or barrier.

“Compartment” means the closed partitioned space that houses the RFID-Tag.

“Component” means a constituent part of the consumer good.

“Concentric” means having a common center.

“Consumer Good” means goods that are ready for consumption by humans that are composed of fluids.

“Convey” means to communicate with.

“Disarmed” means the state of the RFID-Tag in which the Hardwired Logic Circuit will not permit execution of an initiate release signal.

“Deactivate” means to cause to be inactive by rendering a signal.

“Embedded” means affixed to the circuit or fastened to it or programmed within it.

“Enclosed” means closed in all sides.

“Entrance” means a point or place of entering.

“Exit” means a way or passage out.

“Externally” means of or pertaining to the outside of the compartment in which the RFID-Tag is housed.

“Floor” means the bottom level of the compartment housing the RFID-Tag.

“Fluid” means a substance, as a liquid, that is capable of flowing and that changes shape at a steady rate when acted upon by a force tending to change its shape.

“Glued” means joined or fastened with glue.

“Groove” means a long, narrow indentation in the surface.

“Hand-held Scanner” means a device held by hand used to read information off or send commands, such as arm and disarm, to the RFID Tag with Neutralizing Actuator(s).

“Hardwired Logic Circuit” means a circuit that does a logic check such as a microchip, microprocessor, microcontroller, Application Specific Integrated Circuit (“ASIC”) and Field-Programmable Gate Array (“FPGA”) which is integrated within the RFID-Tag or externally coupled with the RFID-Tag.

“Hole” means an opening through something, such as a gasket.

“Instructions” means information imparted to the RFID-Tag about what it should transmit.

“Instruct” means to furnish with orders or directions.

“Interior” means the portion of the compartment housing the RFID-Tag that is within.

“Lateral” means of or pertaining to the side.

“Lead” means a structure to provide physical support by delivering electrical currents to a device.

“Liquid Proof Coating” means a coating added to the shape memory alloys to make them liquid resistant.

“Logic” means the system or principles of reasoning applicable to the Hardwired Logic Circuit and how it functions.

“Logic Check” means the process by which the Hardwired Logic Circuit applies a system or principles of reasoning to check for specific filters.

“Modified” means significantly changed.

“Neutralizing Agent” means the substance that is released to make the consumer good's component fluid unusable.

“Non-conductive Filler Substance” means a substance that does not conduct electrical currents and is used to fill any gaps between the ceiling and floor of the compartment that houses the RFID-Tag and the rest of the compartment.

“Emit” means to send a signal.

“Opening” means a void or gap in space.

“Past” means to be located behind something.

“Pin Switch” means a switch that causes a temporary change in the state of the switch circuit only while the switch is manually actuated.

“Protrude” means to project outward from the interior of the compartment that houses the RFID-Tag.

“Radio Frequency Identification (“RFID”)” means the technologies that use radio waves to automatically identify objects or people.

“RFID-Tag” means an electronic device composed of a microchip that communicates via radio frequencies with an antenna.

“Radio Frequency” means the frequency of transmitting waves of a given radio transmission.

“Receive” means to take in a signal.

“Release” means to emit the neutralizing agent.

“Space” means an area in two dimensions of a particular extent of surface.

“Fluid dispenser” means a complex instrument designed to scatter the fluids into the air in the form of fine particles or otherwise dispense of the liquid from the container.

“Dispenser cap” means a close-fitting covering of the fluid dispenser.

“Transmit” means to send a signal.

“Tubing” means a hollow cylindrical body of material used to channel fluids which is attached to the dispenser cap.

“Unusable” means serving no purpose to the thief.

“Validate” means logical confirmation of filtered information using established system and protocols of logical reasoning.

“Vertical” means being in a position perpendicular to the plane of the horizon.

“Wall” means the permanent upright sides of the compartment housing the RFID-Tag.

As affixed to consumer goods made with fluids, a modified RFID-Tag when activated, and when signaled or asported, releases a neutralizing agent that renders component fluids unusable, is realized by enveloping a series of actuator(s). A RFID-Tag with a Hardwired Logic Circuit with the teachings provided herein can be used to exploit actuator(s) to facilitate the release of a neutralizing agent into the fluid portion of the consumer good.

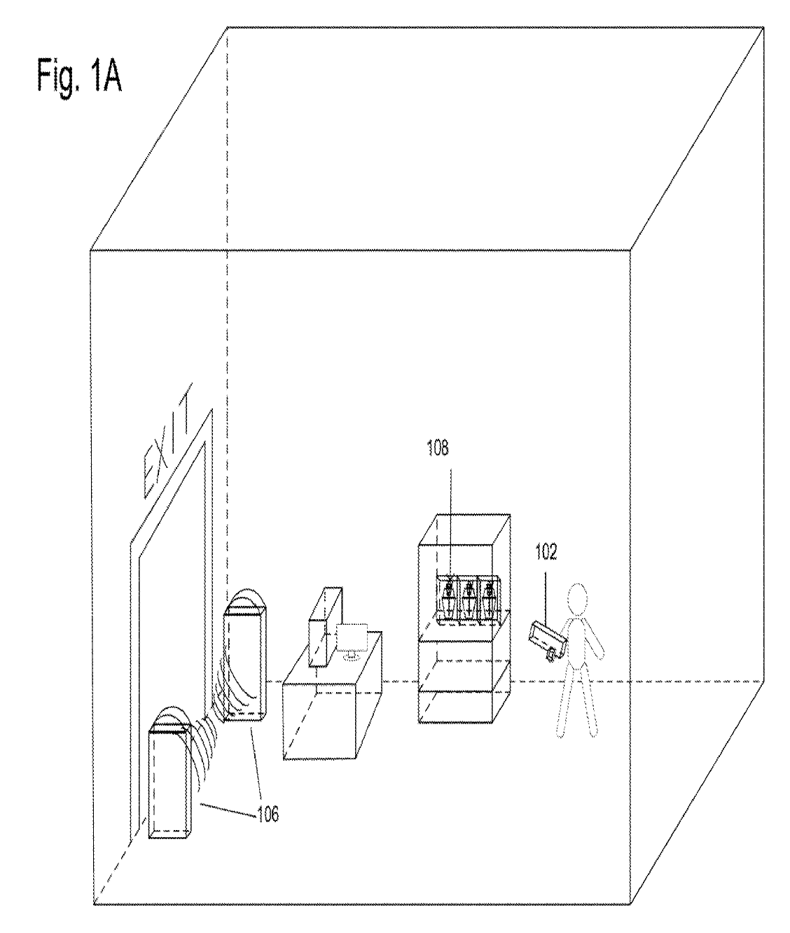

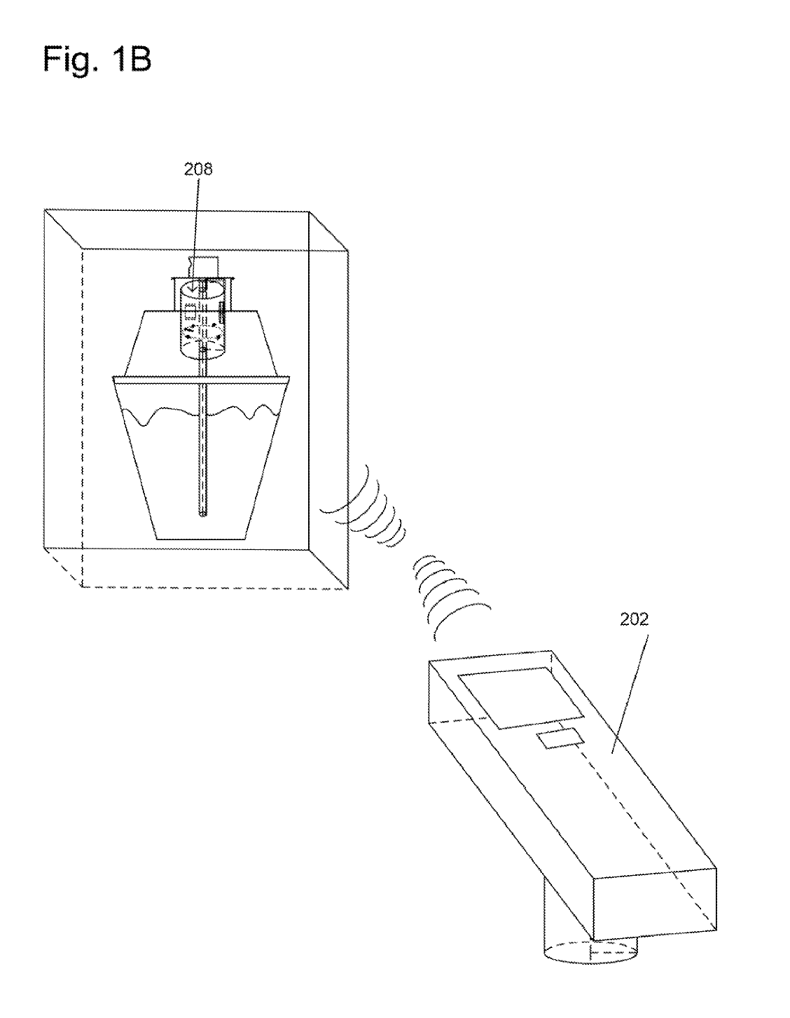

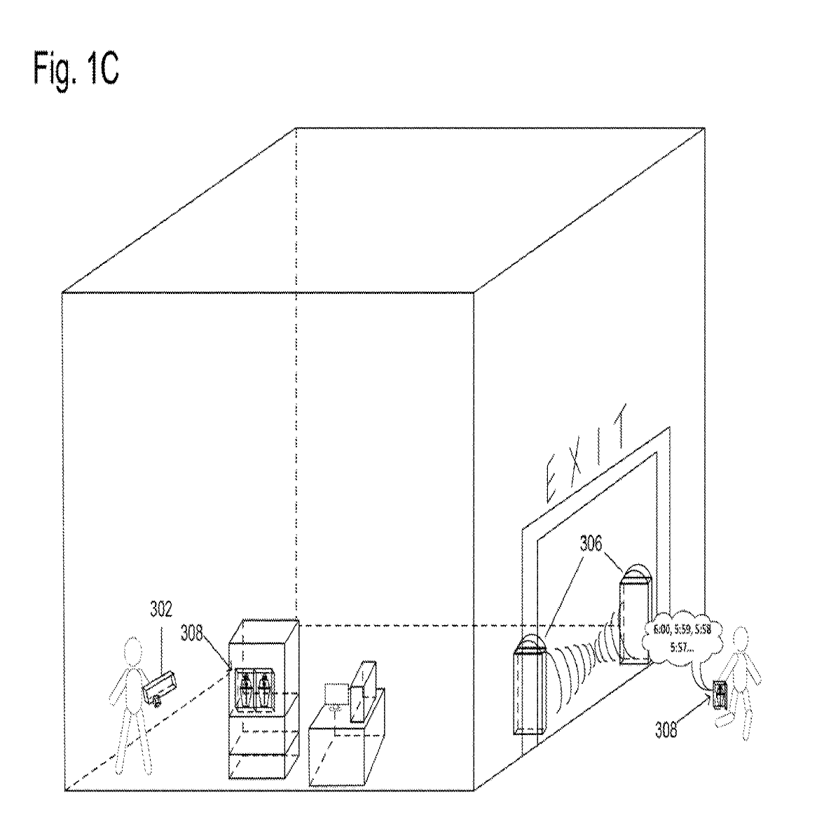

Shown in FIG. 1A is a retail store where consumer goods have been affixed with RFID Tags with Neutralizing Actuator(s). The retailer is holding a hand-held scanner (102); all of the consumer goods have been affixed with RFID Tags with Neutralizing Actuator(s) (108). The RFID-Tags emit and receive radio frequencies to and from the antennae (106) located at the entrance/exit.

FIG. 1B depicts a consumer good composed of fluid, housed in a bottle with a fluid dispenser, affixed with a compartment that houses a RFID-Tag with Neutralizing Actuator(s) (208). The retailer uses a hand-held scanner (202) to transmit an authentication protocol to the RFID-Tag; the RFID-Tag receives the authentication protocol and conveys it to the Hardwired Logic Circuit, which uses embedded logic to confirm it and convey a signal back that it is ready to receive instructions. The retailer then uses the hand-held scanner to transmit instructions to the RFID-Tag. The retailer can transmit a signal to the RFID-Tag to either arm or disarm it. If the RFID-Tag is armed, when a thief attempts to asport the consumer good to which it is attached, when the consumer good comes within range of antennae the RFID-Tag will receive an initiate release signal. When the RFID-Tag receives the signal, its Hardwired Logic Circuit validates the signal and then initiates a countdown that if completed will trigger a release of the compartment bottom half into the consumer good's component's fluids, rendering the fluid unusable. If the retailer disarms the RFID-Tag, it will deny initiate release signals from the antennae. The retailer can also transmit a signal to the RFID-Tag requesting information about the consumer good to which it is attached, such as (1) when the consumer good was manufactured, (2) where the consumer good was manufactured, or (3) what the good's transactional history has been.

FIG. 1C shows what happens at the retail store when a thief asports the consumer good (308) affixed with the RFID-Tag with Neutralizing Actuator(s) that has been armed by a retailer with a hand-held scanner (302) past the antennae at the entrance/exit. The RFID-Tag receives an initiate release signal from the antennae (306) when the RFID-Tag comes within proximity of the antennae. When the RFID-Tag receives the signal, its Hardwired Logic Circuit validates the signal and then initiates a countdown that if completed will trigger a release of the compartment bottom half into the consumer good's component's fluids, rendering it unusable.

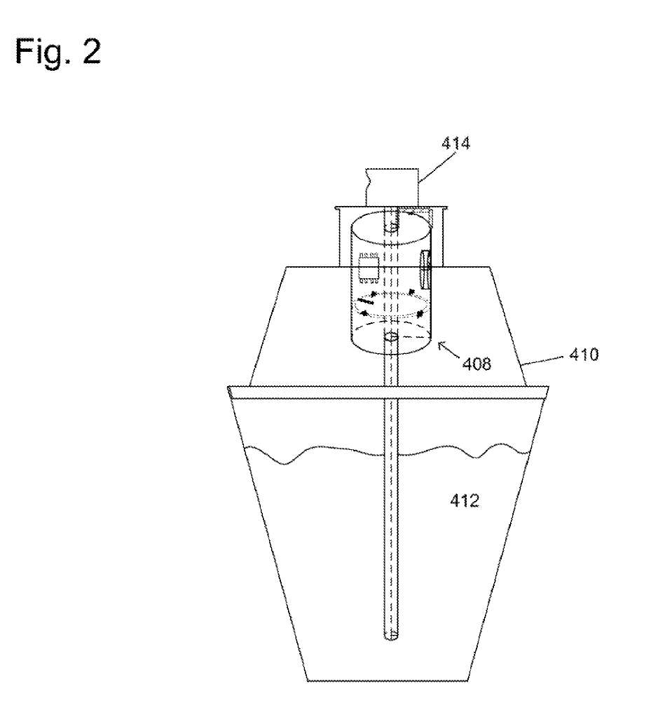

FIG. 2 shows a consumer good composed of fluid, housed in a bottle (410). The bottle has a fluid dispenser comprised of a dispenser cap at the top (414) which is attached to tubing that may be cylindrical that extends downward into the fluid (412). The tubing passes through a RFID Tag with Neutralizing Actuator(s) (408) via a lateral circular opening. The dispenser cap dispenses the fluid after it is pumped to the cap through the tubing.

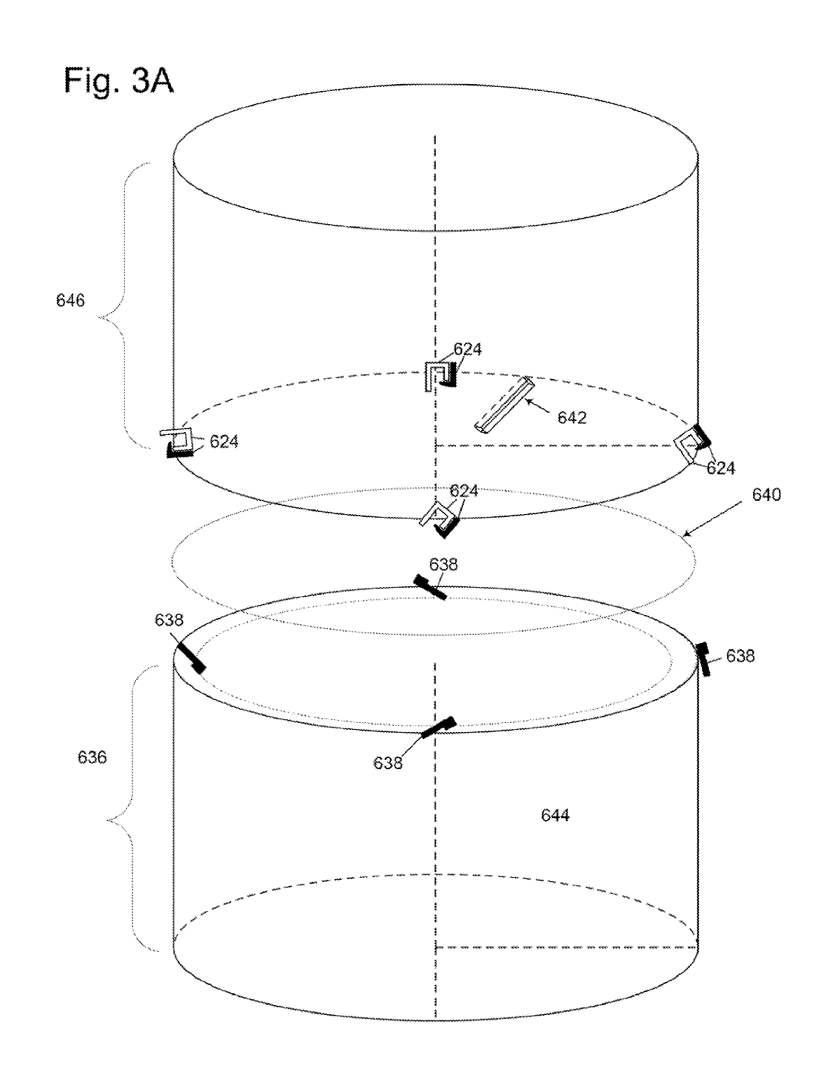

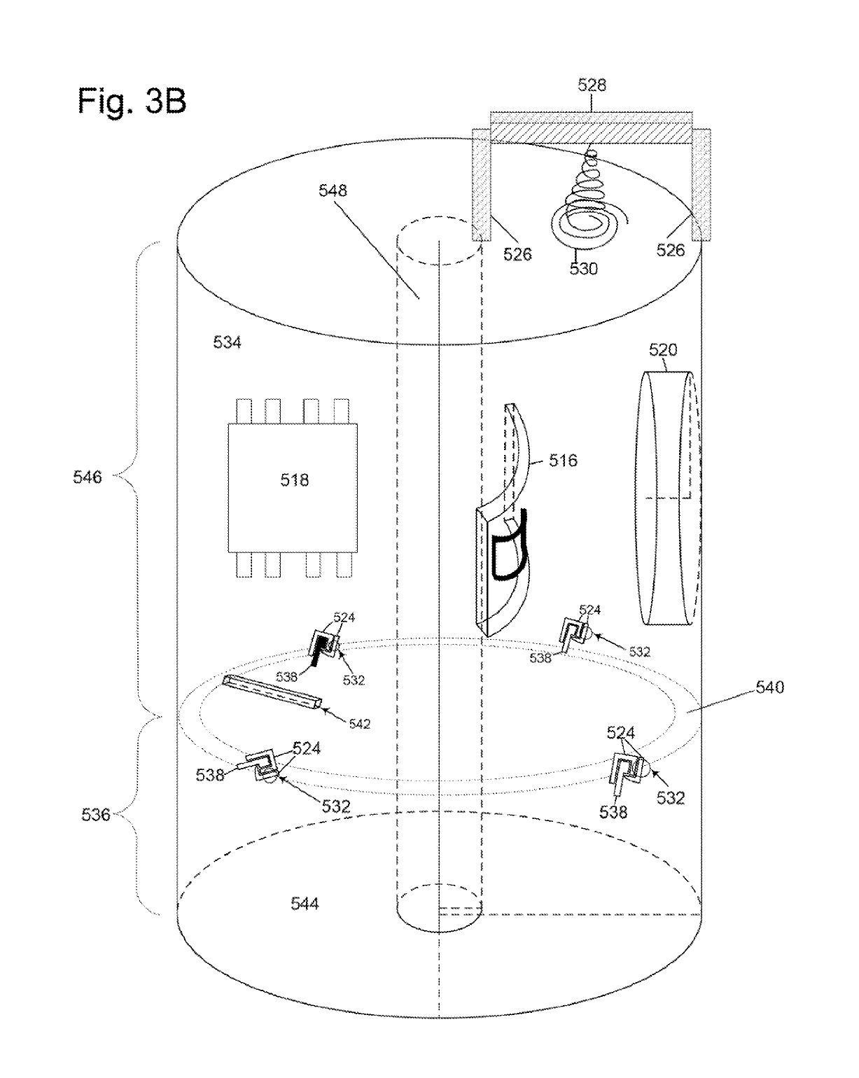

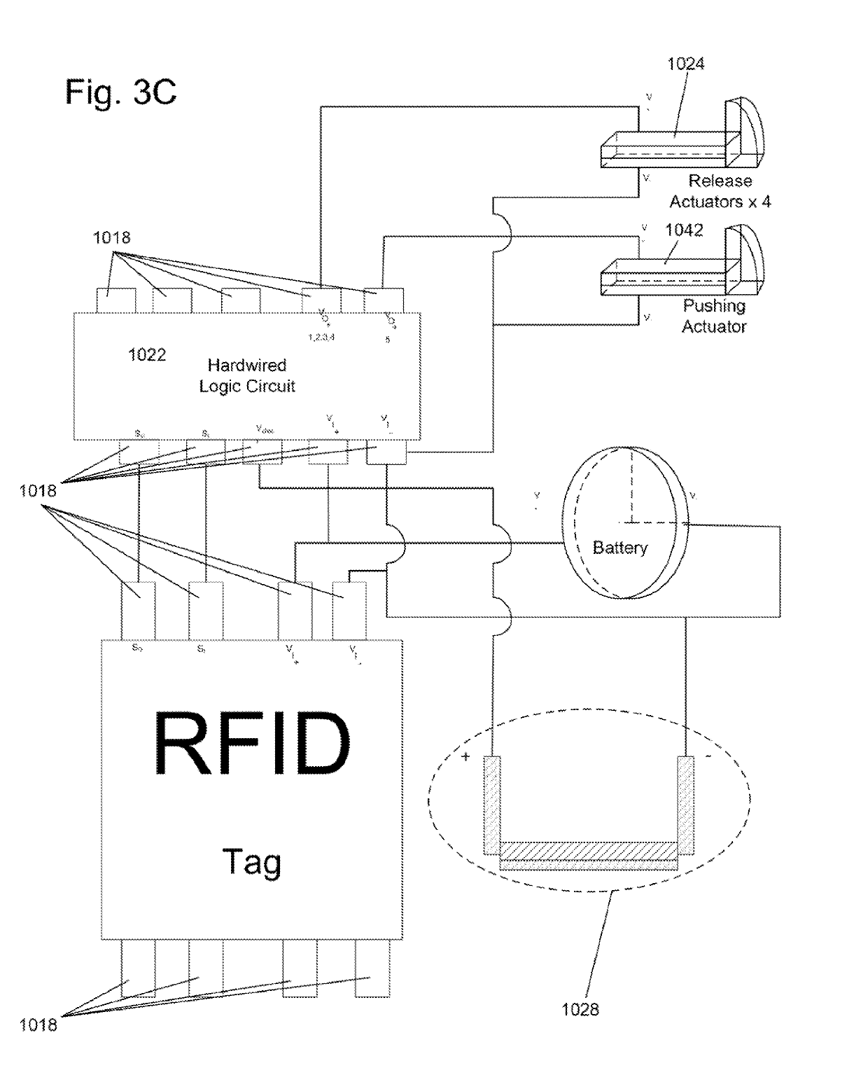

The consumer good when housed in a bottle has a fluid dispenser whose tubing can be easily run through a compartment that may be cylindrical with an enclosed vertical center. FIGS. 3A-B depicts the compartment that houses the RFID-Tag with Neutralizing Actuator(s) and its components.

FIG. 3A shows the compartment (508) with an enclosed vertical center (548), RFID-Tag (518), Hardwired Logic Circuit (516), pin switch (526), insert (536), and a battery (520). The bottom face of the insert (536) rests in a notch above a hole in the base of the compartment (508). Located on the compartment's interior wall, the RFID-Tag (518), Hardwired Logic Circuit (516), battery (520), and pin switch (526) and are all connected to each other by electrical wires (1072) and are glued to the wall and covered by non-conductive filler substance. The piston of the pin switch (526) protrudes above the top of the compartment and is connected to the dispenser cap (414).

FIG. 3B shows the insert (536) comprising the top cap (660), top tube (662), firebreak (664), capsule holder (666), shape memory alloys (670), and two electrical wires (672). The top tube (662) is a hollow cylinder. The top cap (660) is a thin cylindrical lid that covers the top tube (662) and secured together by glue. The top tube (662) is notched to allow the two electrical wires (672) to run through it. The firebreak (664) is a thick cylindrical lid that has small vertical slits (674) within it that allow for the shape memory alloys (670) to pass through it and is secured to the bottom of the top tube (662) by glue. The capsule (680) that is cup shaped is connected to the interior of the capsule holder (666), which is hollow and cylindrical in shape, by tabs (682). Above the capsule holder (666) and vertically aligned with the tabs (682) are an equal number of slits (674) in the firebreak (664). Two electrical wires (672) runs through the notches of the top tube (662). Length(s) of shape memory alloys (670) run from one electrical wire (672) down through the slits in firebreak (664) and around its respective tab (682) and back up to the other electrical wire (672). The capsule holder (680) is secured to the bottom of the firebreak (674) by glue. The open face of the capsule (680) within the capsule holder (666) is flush with the bottom of the firebreak (664), which seals the encapsulated neutralizing agent.

When the fluid dispenser is depressed by pressing the dispenser cap, the pin switch (526) is also depressed, thus completing the switch circuit. Upon such manual activation of the pin switch (526), the Hardwired Logic Circuit (516) does a logic check.

As reflected in FIG. 3A but shown in more detail in FIG. 3C, extending from the Hardwired Logic Circuit (1016) are pins (1090); some of the pins connect to the pin switch (1026), some of the pins connect to shape memory alloys (1070), while the other pins connect to the RFID-Tag (1018) and the battery (1020).

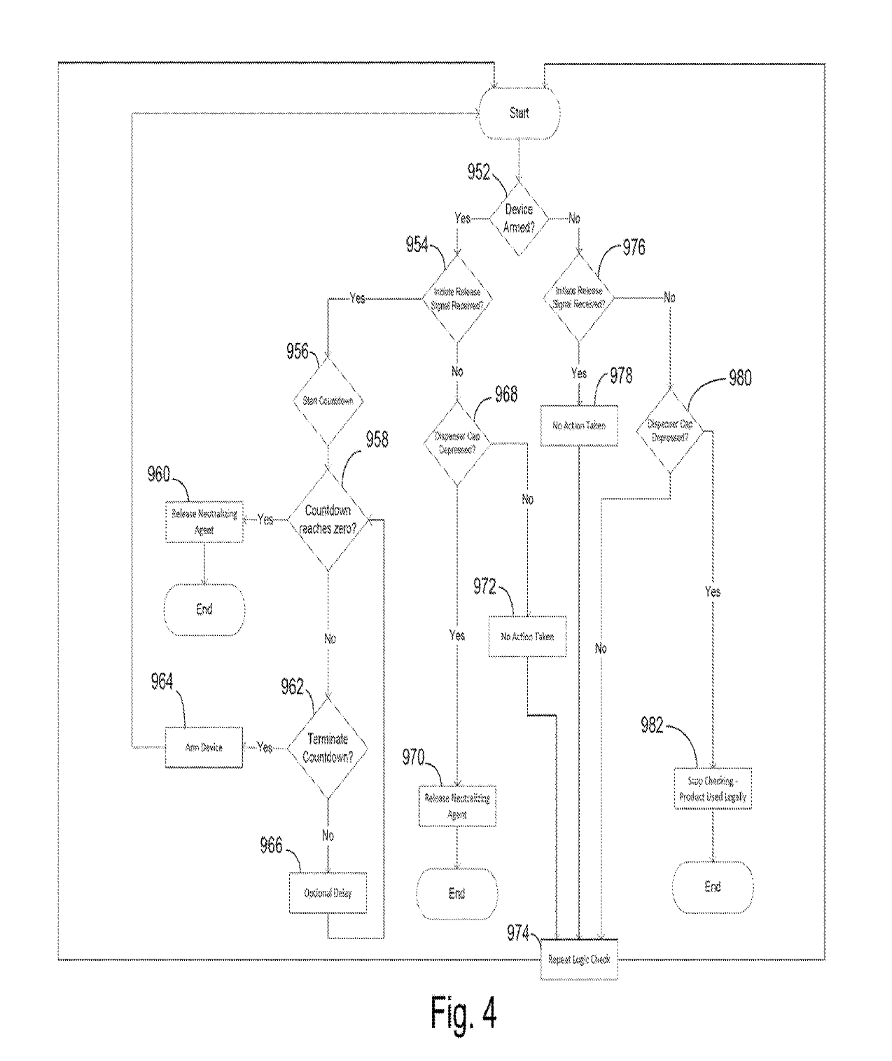

FIG. 4 shows the Hardwired Logic Circuit logic. If the RFID-Tag (518) is armed, then the Hardwired Logic Circuit logic will determine if there is any initiate release signal. If the RFID-Tag receives an initiate release signal from either (i) antennae, such as those at the store's entrance or exit, or (ii) the switch circuit, upon manual activation when the pin switch (526) is depressed and the switch circuit is complete, then the Hardwired Logic Circuit does a logic check. If the initiate release signal originated from the antenna, then the Hardwired Logic Circuit logic will determine if a valid release instruction has occurred, and a timer will begin counting down (956); when the timer reaches zero (0), the logic determines that a release is authorized. The bottom compartment is released when the Hardwired Logic Circuit logic permits the battery to send an electrical current into the shape memory alloys. When an electric current is applied to the shape memory alloys (670) by way of the electrical wires (672), the shape memory alloys (670) contract upwards. The tabs (682) are broken by the force of the contraction of the shape memory alloys (670). However, the firebreak (664) prevents the shape memory alloys (670) from breaking other parts of the insert (536). When the tabs (682) break, the capsule (680) drops into the fluid (412).

Upon dropping into the liquid product, the neutralizing agent contained in the capsule then mingles with the liquid product until it is rendered unusable. If the RFID-Tag receives a terminate release signal, such as from a hand-held scanner, the Hardwired Logic Circuit resets the device to armed state default. If the initiate release signal originated from manual activation of the RFID-Tag's switch circuit, the battery sends an electrical current into electrical current into the shape memory alloys. Upon dropping into the liquid product, the neutralizing agent contained in the contained in the capsule then mingles with the liquid product until it is rendered unusable. If the device is disarmed, then the Hardwired Logic Circuit will deny any initiate release signal. The result is that the tabs connecting the capsule to the capsule holder remains intact and the capsule remains locked in the insert.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. An apparatus comprising:
a. a container of a liquid good;
b. a container of a neutralizing agent positioned in operational relation to the container of a good to dispense the neutralizing agent into the container of goods;
c. a detection unit; and
d. a release mechanism responsive to the detection unit to dispense the neutralizing agent into the container of goods.

2. An apparatus in claim 1 wherein the detection unit comprises an RFID-Tag.

3. An apparatus in claim 1 wherein the liquid good is a consumer good.

4. An apparatus in claim 3 wherein the detection unit comprises an RFID-Tag.

5. A method of deterring unauthorized asportation of a good comprising steps of:
a. providing a container of a liquid good;
b. providing a container of a neutralizing agent disposed to dispense the neutralizing agent into the container of a good;
c. providing a detection unit;
d. detecting triggering condition; and
e. upon detection of the triggering condition, dispensing the neutralizing agent into the container of a good.

6. A method in claim 5 wherein the detection unit comprises an RFID-Tag.

7. A method in claim 5 wherein the liquid good is a consumer good.

8. A method in claim 7 wherein the detection unit comprises an RFID-Tag.
